(19) United States
(12) Patent Application Publication
(10) Pub. No.: US 2019/0009684 A1
(43) Pub. Date: Jan. 10, 2019

(54) POWER SYSTEM

(71) Applicants: AutoNetworks Technologies, Ltd., Yokkaichi (JP); Sumitomo Wiring Systems, Ltd., Yokkaichi (JP); SUMITOMO ELECTRIC INDUSTRIES, LTD., Osaka (JP)

(72) Inventor: Hiromichi Yasunori, Yokkaichi (JP)

(73) Assignees: AutoNetworks Technologies, Ltd., Yokkaichi, Mie (JP); SUMITOMO ELECTRIC INDUSTRIES, LTD., Osaka-shi, Osaka (JP); Sumitomo Wiring Systems, Ltd., Yokkaichi, Mie (JP); SUMITOMO ELECTRIC INDUSTRIES, LTD., Osaka-shi, Osaka (JP)

(21) Appl. No.: 15/988,008

(22) Filed: May 24, 2018

(30) Foreign Application Priority Data
Jul. 5, 2017 (JP) 2017-143682

(51) Int. Cl. B60L 11/18; H02M 3/04

(52) U.S. Cl. CPC B60L 11/1851; H02M 3/04

(57) ABSTRACT

Provided is a power system that is able to readily address design changes, together with suppressing leakage current from a conduction path of a high voltage to a conduction path of a low voltage. A power system is provided with a voltage transformation device that steps down an input voltage to a 12V voltage that is lower than the 48V voltage and outputs the resultant voltage, a high-voltage power box that is electrically connected to the voltage transformation device and outputs electric power having a voltage of 48V, and a low-voltage power box that is electrically connected to the voltage transformation device and outputs electric power having a voltage of 12V, the voltage transformation device and the high-voltage power box being detachably connected to each other.

### CROSS-REFERENCE TO RELATED APPLICATIONS

This application claims priority of Japanese Patent Application No. JP 2017-143682 filed Jul. 25, 2017.

### TECHNICAL FIELD

The technology disclosed in this specification relates to a power system.

### BACKGROUND

Conventionally, batteries having a voltage of 12V are mounted in vehicles. Recently, in order to supply electric power to devices that requires a comparatively large amount of power, such as electric turbochargers, the possibility of mounting batteries with a voltage higher than 12V has been examined. Since a higher voltage means less current is required given the same amount of power, power transmission loss which is proportional to the current value can be reduced.

JP 2016-222085A discloses a configuration in which a 48V battery having a voltage of 48V is mounted in a vehicle. The 48V battery is electrically connected to a power control box by a power line. The power control box is electrically connected by a first supply line to a 48V load that operates at a voltage of 48V. The power control box is provided with a DC-DC converter that steps down the voltage from 48V to 12V. The power control box is electrically connected by a second supply line to a 12V load that operates at a voltage of 12V. The electric power stepped down to 12V by the DC-DC converter is supplied to a 12V load.

Examples of conventional technologies related to this application include JP 2016-222085A.

However, with the above configuration, a 48V conduction path and a 12V conduction path are provided together within the power control box. In the case where conduction paths of different voltages are provided close together, there is concern about current leaking from the high-voltage side to the low-voltage side. When current having a voltage of 48V leaks to the 12V conduction path, there is a risk of a fault occurring in the 12V load connected to this conduction path.

Also, in the above configuration, the 48V battery and the power control box are connected to the power line, and the power control box and the 48V load are connected to the first supply line. Because of the risk of a fault occurring in the 12V load when current having a voltage of 48V leaks to the 12V conduction path, as described above, the power line through which current having a voltage of 48V flows and the first supply line must be protected by an insulating material so as to not contact the 12V conduction path, thus giving rise to a problem in that the weight of the power control box increases. It is thus desirable to reduce the used amount of electrical wire through which current having a voltage of 48V flows as much as possible.

Also, with the above configuration, even in the case where, for example, only the configuration of the DC-DC converter needs to be changed, the design of the entire power control box must be changed. There is thus a problem in that design changes cannot readily be addressed.

The technology disclosed in this specification was completed based on circumstances such as described above, and an object thereof is to provide a power system that can readily address design changes, together with suppressing leakage current from a conduction path of a high voltage to a conduction path of a low voltage.

### SUMMARY

The technology disclosed in this specification is a power system that is provided with a voltage transformation device configured to step down an input first voltage to a second voltage lower than the first voltage and to output the resultant voltage, a high-voltage power box electrically connected to the voltage transformation device and configured to output electric power of the first voltage, and a low-voltage power box electrically connected to the voltage transformation device and configured to output electric power of the second voltage, the voltage transformation device and the high-voltage power box being configured to be detachably connected to each other.

According to the above configuration, because the first voltage is applied to the input side and the second voltage is applied to the output side in the voltage transformation device, the portion to which the first voltage is applied and the portion to which the second voltage is applied are separated. The occurrence of leakage between the portion to which the first voltage is applied and the portion to which the second voltage is applied in the voltage transformation device is thereby suppressed.

Also, only the first voltage is applied to the high-voltage power box, and only the second voltage is applied to the low-voltage power box. The occurrence of leakage within the high-voltage power box and the occurrence of leakage within the low-voltage power box are thus suppressed.

According to the above configuration, the amount of the electrical wire that is used can be reduced, compared to the case where the voltage transformation device and the high-voltage power box are connected by electrical wire.

According to the above configuration, in the case where a change in the design of the voltage transformation device is required, the design of only the voltage transformation device need be changed, thus enabling design changes to be readily addressed.

Because the configuration other than the above is substantially similar to the first embodiment, the same reference signs are given to members that are the same, and redundant description will be omitted.

The voltage transformation device is preferably provided with a circuit board and a voltage-transformation side busbar, the high-voltage power box is preferably provided with a high-voltage side busbar, and the voltage-transformation side busbar and the high-voltage side busbar are preferably electrically connected by a bolt and a nut screwed onto the bolt.

According to the above configuration, the voltage-transformation side busbar and the high-voltage side busbar can be reliably connected, using a simple configuration such as a bolt and a nut.

A circuit board of the voltage transformation device preferably has a voltage-transformation side input conduction path to which the first voltage is applied, a voltage-transformation side first branch path branching from the voltage-transformation side input conduction path and electrically connected to the voltage-transformation side busbar, and a voltage-transformation side second branch path branching from the voltage-transformation side input conduction path and electrically connected to a DC-DC converter.

According to the above configuration, on the input side of the voltage transformation device, the conduction path to which the first voltage is applied can be branched to the high-voltage power box side and the DC-DC converter side. Because this branch structure is provided on the side to which only the first voltage is applied, leakage to the conduction path to which the second voltage is applied will be suppressed.

The high-voltage power box preferably has a high-voltage side input conduction path to which the first voltage is applied, a high-voltage side first branch path branching from the high-voltage side input conduction path and electrically connected to the high-voltage side busbar, and a high-voltage side second branch path branching from the high-voltage side input conduction path and configured to supply electric power to a first load that operates at the first voltage.

According to the above configuration, within the high-voltage power box, the high-voltage side input conduction path to which the first voltage is applied can be branched to a high-voltage side first branch path that branches to the voltage transformation device via the high-voltage side busbar and a high-voltage side second branch path that supplies electric power to the first load. Because this branch structure is provided in the high-voltage power box to which only the first voltage is applied, leakage to the conduction path to which the second voltage is applied will be suppressed.

A first load that operates with electric power of the first voltage is preferably electrically connected to the high-voltage power box, in the high-voltage power box, a semiconductor switching element is preferably arranged between the high-voltage side busbar and the first load, a control unit is preferably arranged in the voltage transformation device, and the control unit is preferably configured to turn off the semiconductor switching element, when it is detected that an overcurrent flowed between the high-voltage side busbar and the first load.

According to the above configuration, a fuse is not required, thus enabling an arc that occurs when removing a fuse from a high-voltage power box at the time of fuse replacement to be suppressed.

According to the technology disclosed in this specification, a power system can be provided that is able to readily address design changes, together with suppressing leakage current from a conduction path of a high voltage to a conduction path of a low voltage.

### BRIEF DESCRIPTION OF THE DRAWINGS

FIG. 1 is a schematic view showing a state in which a power system according to a first embodiment is applied to a vehicle.

FIG. 2 is a block diagram showing the electrical configuration of the power system according to the first embodiment.

FIG. 3 is a cross-sectional view showing a connection structure of a voltage transformation device and a high-voltage power box.

FIG. 4 is a block diagram showing the electrical configuration of a power system according to a second embodiment.

FIG. 5 is a block diagram showing the electrical configuration of a power system according to a third embodiment.

### DETAILED DESCRIPTION OF PREFERRED EMBODIMENTS

### First Embodiment

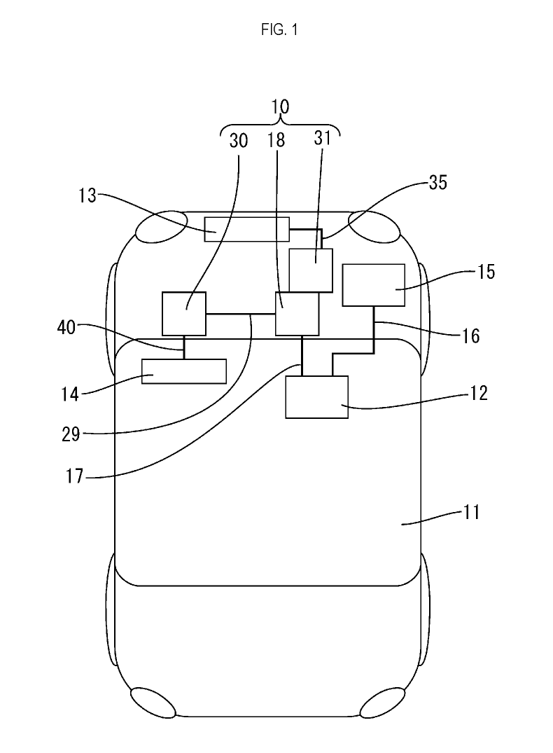

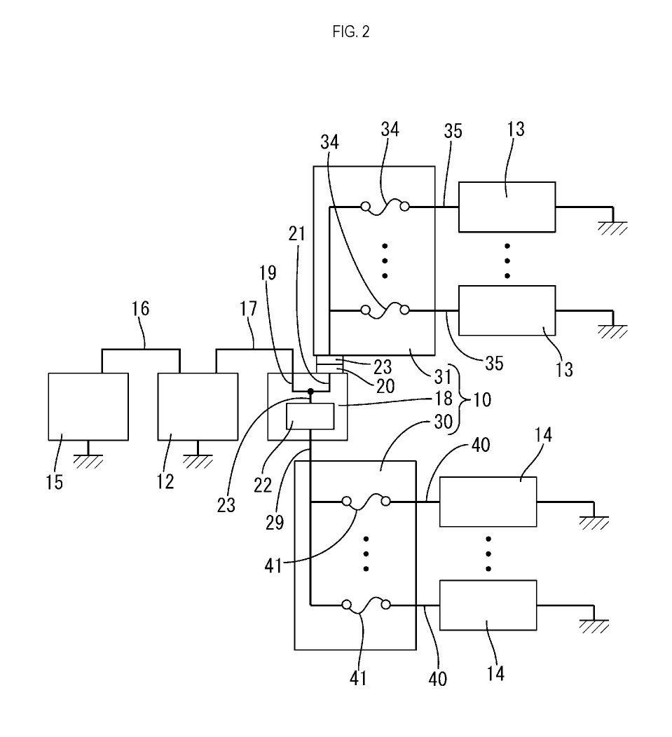

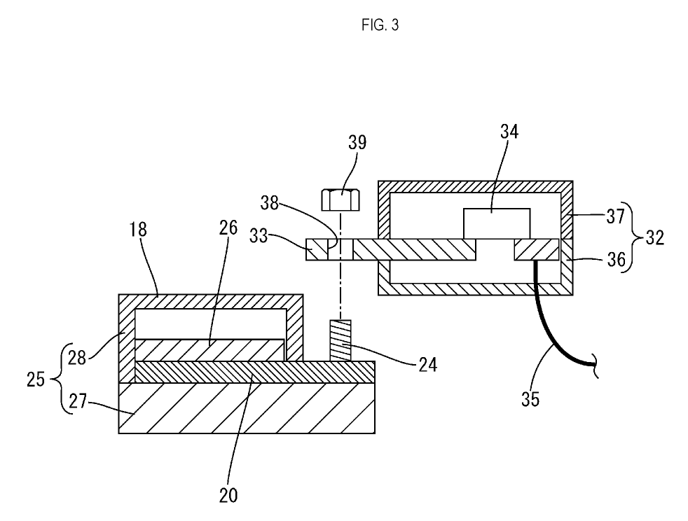

A first embodiment of the technology disclosed in this specification will be described, with reference to FIGS. 1 to 3. A power system 10 according to the present embodiment is mounted in a vehicle 11, and supplies electric power that is supplied from a 48V electrical storage device 12 to a 48V load 13 (first load) and a 12V load 14 (second load). In the following description, a reference sign may be given to only one of a plurality of members that are the same, and reference signs may be omitted for the other members.

48V Generator 15

A 48V generator 15 is mounted in the vehicle 11. The 48V generator 15 generates electricity using power that is supplied from a power source which is not illustrated. In the case where the vehicle 11 is equipped with an internal combustion engine, the 48V generator 15 generates electricity using power that is supplied from the internal combustion engine. In the case where the vehicle 11 is an electric car or a hybrid car, the 48V generator 15 converts the kinetic energy of the vehicle 11 into electric power when the vehicle 11 decelerates. The voltage of the electric power that is generated by the 48V generator 15 is slightly higher than 48V (first voltage).

The 48V generator 15 generates alternating-current power. The generated alternating current is converted into direct current by a rectifier which is not illustrated. The 48V generator 15 is electrically connected to the 48V electrical storage device 12 by a first power line 16. The first power line 16 may be an electrical wire or may be a busbar consisting of a metal plate material. The electric power generated by the 48V generator 15 is charged to the 48V electrical storage device 12.

48V Electrical Storage Device 12

The 48V electrical storage device 12 supplies electric power having a voltage of 48V to other in-vehicle devices. The 48V electrical storage device 12 is constituted by a plurality of electrical storage elements (not shown) connected in series. The electrical storage elements may be secondary batteries such as lithium-ion batteries or may be capacitors. The 48V electrical storage device 12 is electrically connected to a voltage transformation device 18 by a second power line 17. The second power line 17 may be an electrical wire or may be a busbar consisting of a metal plate material.

Voltage Transformation Device 18

The voltage transformation device 18 according to the present embodiment steps down electric power having a voltage of 48V input from the 48V electrical storage device 12 to 12V (second voltage) and outputs the resultant power. Also, the voltage transformation device 18 according to the present embodiment outputs the electric power having a voltage of 48V input from the 48V electrical storage device 12, without performing voltage transformation. The voltage transformation device 18 has a voltage-transformation side input conduction path 19 that is electrically connected to the second power line 17, a voltage-transformation side first branch path 21 branching from the voltage-transformation side input conduction path 19 and electrically connected to a voltage-transformation side busbar 20, and a voltage-transformation side second branch path 23 branching from the voltage-transformation side input conduction path 19 and electrically connected to a DC-DC converter 22.

The voltage-transformation side busbar 20 is constituted by press processing a metal plate material into a predetermined shape. As the metal constituting the voltage-transformation side busbar 20, a suitable metal can be appropriately selected according to need, such as copper, a copper alloy, aluminum or an aluminum alloy. A plating layer which is not illustrated may be formed on the surface of the voltage-transformation side busbar 20. As the metal constituting the plating layer, a suitable metal can be appropriately selected according to need, such as tin or nickel.

A stud bolt 24 (bolt) that extends in a direction intersecting the plate surface of the voltage-transformation side busbar 20 is attached to the voltage-transformation side busbar 20. The stud bolt 24 is fixed to the voltage-transformation side busbar 20 using a suitable technique according to need, and may be welded to the voltage-transformation side busbar 20, screwed into the voltage-transformation side busbar 20, or pressed fitted to the voltage-transformation side busbar 20.

The voltage transformation device 18 is provided with a case 25, a circuit board 26 arranged inside of the case 25, and the voltage-transformation side busbar 20 which is connected to the circuit board 26 and exposed outside of the case 25. The case 25 has a lower case 27 and an upper case 28 attached to the lower case 27.

The circuit board 26 is constituted by forming a conduction path (not shown) in an insulated substrate using a printed wiring technology. In the circuit board 26, the voltage-transformation side input conduction path 19, the voltage-transformation side first branch path 21 and the voltage-transformation side second branch path 23 are laminated in a state of being insulated from a conduction path formed in the circuit board 26. The voltage-transformation side input conduction path 19, the voltage-transformation side first branch path 2 and the voltage-transformation side second branch path 23 are constituted by press processing a metal plate material into a predetermined shape.

A coil (not shown) and the DC-DC converter 22, which is provided with a plurality of switches (not shown) connected to the coil, are formed in the circuit board 26.

The voltage transformation device 18 is provided with an output electrical wire 29 connected to the DC-DC converter 22. The output electrical wire 29 is lead out of the case 25 and electrically connected to a low-voltage power box 30. The output electrical wire 29 and the DC-DC converter 22 are electrically connected using a well-known technique. A suitable connection structure can be appropriately selected according to need, such as, for example, the output electrical wire 29 and the DC-DC converter 22 being connected via a substrate connector (not shown) arranged on the circuit board 26, or the conduction path of the circuit board 26 and the output electrical wire 29 being soldered together.

High-Voltage Power Box 31

A high-voltage power box 31 is provided with a case 32, a high-voltage side busbar 33 lead out of the case 32, a 48V fuse 34 electrically connected to the high-voltage side busbar 33, and a 48V power supply line 35 electrically connected to the 48V fuse 34 and lead out of the case 25. The case 32 is constituted by attaching a lower case 36 to an upper case 37.

The high-voltage power box 31 supplies electric power having a voltage of 48V input from the high-voltage side busbar 33 to a plurality of 48V loads 13 that operate with electric power having a voltage of 48V, via the 48V power supply line 35. In the high-voltage power box 31, the 48V fuse 34 which is used for current having a voltage of 48V is installed for every 48V load 13.

The 48V load 13 can be, for example, a heater, an electric turbocharger, power steering or power brakes, but is not limited thereto.

The high-voltage side busbar 33 is constituted by press processing a metal plate material into a predetermined shape. As the metal constituting the high-voltage side busbar 33, a suitable metal can be appropriately selected according to need, such as copper, a copper alloy, aluminum or an aluminum alloy. A plating layer which is not illustrated may be formed on the surface of the high-voltage side busbar 33. As the metal constituting the plating layer, a suitable metal can be appropriately selected according to need, such as tin or nickel.

A through hole 38 that passes through the high-voltage side busbar 33 is provided in the high-voltage side busbar 33. The inner diameter size of the through hole 38 is formed to be larger than the outer diameter size of the stud bolt 24. The high-voltage side busbar 33 is configured to be stacked on the voltage-transformation side busbar 20 in a state in which the stud bolt 24 is inserted through the through hole 38. A nut 39 is configured to be screwed onto the stud bolt 24. The voltage-transformation side busbar 20 and the high-voltage side busbar 33 are physically and electrically connected, by the nut 39 being screwed onto the stud bolt 24.

Low-Voltage Power Box 30

The low-voltage power box 30 and the output electrical wire 29 are electrically connected using a well-known technique. A suitable technique can be appropriately selected according to need, such as, for example, adopting a configuration in which a connector (not shown) arranged on a terminal of the output electrical wire 29 is fitted into a connector (not shown) provided in the low-voltage power box 30.

The low-voltage power box 30 supplies electric power having a voltage of 12V supplied from the output electrical wire 29 to a plurality of 12V loads 14 that operate with electric power having a voltage of 12V, via a 12V power supply line 40. In the low-voltage power box 30, a 12V fuse 41 that is used for current having a voltage of 12V is installed for every 12V load 14.

The 12V load 14 can be, for example, lights, a car navigation system, a horn or windshield wipers, but is not limited thereto.

Operation and Effects of Embodiment

Next, the operation and effects of the present embodiment will be described. The power system 10 according to the present embodiment is provided with the voltage transformation device 18 which steps down an input voltage of 48V to a voltage of 12V that is lower than 48V and outputs the resultant voltage, the high-voltage power box 31 which is electrically connected to the voltage transformation device 18 and outputs electric power having a voltage of 48V, and the low-voltage power box 30 that is electrically connected to the voltage transformation device 18 and outputs electric power having a voltage of 12V, and the voltage-transformation side busbar 20 provided in the voltage transformation device 18 and the high-voltage side busbar 33 provided in the high-voltage power box 31 are detachably connected to each other.

According to the present embodiment, because the 48V voltage is applied to the input side and the 12V voltage is applied to the output side in the voltage transformation device 18, the portion to which the 48V voltage is applied and the portion to which the 12V voltage is applied are separated. The occurrence of leakage between the portion to which a 48V voltage is applied and the portion to which a 12V voltage is applied in the voltage transformation device 18 is thereby suppressed.

Also, only a 48V voltage is applied to the high-voltage power box 31, and only a 12V voltage is applied to the low-voltage power box 30. The occurrence of leakage within the high-voltage power box 31 and the occurrence of leakage within the low-voltage power box 30 are thus suppressed.

Also, according to the present embodiment, the amount of the electrical wire that is used can be reduced, compared to the case where the voltage transformation device 18 and the high-voltage power box 31 are connected by electrical wire.

According to the present embodiment, in the case where a change in the design of the voltage transformation device 18 is required, only the design of the voltage transformation device 18 need be changed, thus enabling design changes to be readily addressed.

Also, according to the present embodiment, the voltage-transformation side busbar 20 and the high-voltage side busbar 33 are connected, by the stud bolt 24 and the nut 39 that is screwed onto the stud bolt 24. Thus, the voltage-transformation side busbar 20 and the high-voltage side busbar 33 can be reliably connected, using a simple configuration such as the stud bolt 24 and the nut 39.

Also, according to the present embodiment, the voltage transformation device 18 has the voltage-transformation side input conduction path 19 to which a 48V voltage is applied, the voltage-transformation side first branch path 21 branching from the voltage-transformation side input conduction path 19 and electrically connected to the voltage-transformation side busbar 20, and the voltage-transformation side second branch path 23 branching from the voltage-transformation side input conduction path 19 and electrically connected to the DC-DC converter 22. On the input side of the voltage transformation device 18, the conduction path to which the 48V voltage is applied can thereby be branched to the high-voltage power box 31 side and to the DC-DC converter 22 side. Because this branch structure is provided on the side to which only the 48V voltage is applied, leakage to the conduction path to which the 12V voltage is applied will be suppressed.

Also, according to the present embodiment, the 48V fuse 34 is arranged in the high-voltage power box 31, and the 12V fuse 41 is arranged in the low-voltage power box 30 which is a different member from the high-voltage power box 31. Erroneously installing the 48V fuse 34 and the 12V fuse 41 will thereby be suppressed.

### Second Embodiment

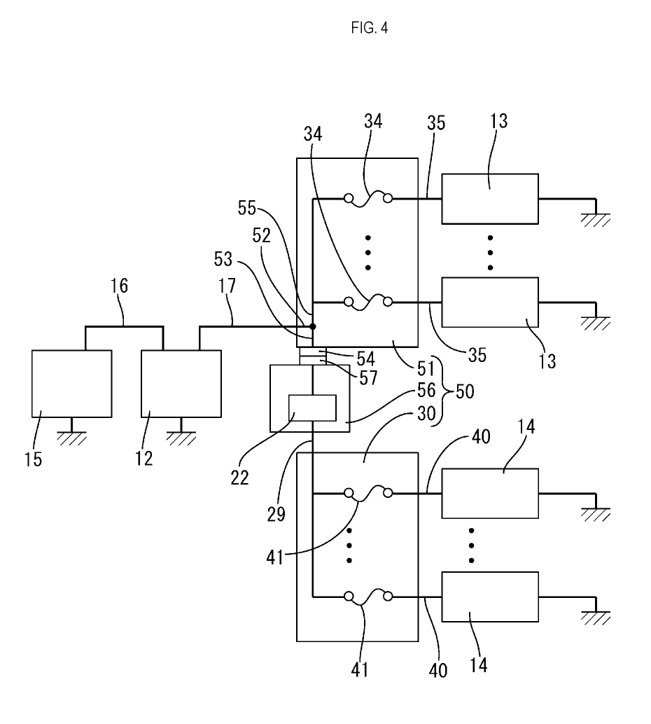

Next, a second embodiment of the technology disclosed in this specification will be described, with reference to FIG. 4. In a power system 50 according to the present embodiment, a high-voltage power box 51 has a high-voltage side input conduction path 52 electrically connected to a 48V electrical storage device 12, a high-voltage side first branch path 53 branching from the high-voltage side input conduction path 52 and electrically connected to a high-voltage side busbar 54, and a high-voltage side second branch path 55 branching from the high-voltage side input conduction path 52 and supplying electric power to a 48V load. The high-voltage side input conduction path 52, as a result of being electrically connected to the 48V electrical storage device 12, will have a voltage of 48V applied thereto.

A voltage transformation device 56 has a DC-DC converter 22 electrically connected to a voltage-transformation side busbar 57. The voltage transformation device 56 according to the present embodiment will be supplied electric power having a voltage of 48V from the high-voltage side busbar 54 of the high-voltage power box 51, via the voltage-transformation side busbar 57. The electric power having a voltage of 48V is stepped down to 12V by the DC-DC converter 22, and the resultant power is supplied to the low-voltage power box 30 via the output electrical wire 29.

Because the configuration other than the above is substantially similar to the first embodiment, the same reference signs are given to members that are the same, and redundant description will be omitted.

In the present embodiment, the high-voltage power box 51 has the high-voltage side input conduction path 52 to which a 48V voltage is applied, the high-voltage side first branch path 53 branching from the high-voltage side input conduction path 52 and electrically connected to the high-voltage side busbar 54, and the high-voltage side second branch path 55 branching from the high-voltage side input conduction path 52 and supplying electric power to the 48V load 13. Within the high-voltage power box 51, the high-voltage side input conduction path 52 to which a 48V voltage is applied is thereby able to branch to the high-voltage side first branch path 53 that branches to the voltage transformation device 56 via the high-voltage side busbar 57 and to the high-voltage side second branch path 55 that branches to the 48V load 13. Because this branch structure is provided in the high-voltage power box 51 to which only a 48V voltage is applied, leakage to the conduction path to which a 12V voltage is applied is suppressed.

### Third Embodiment

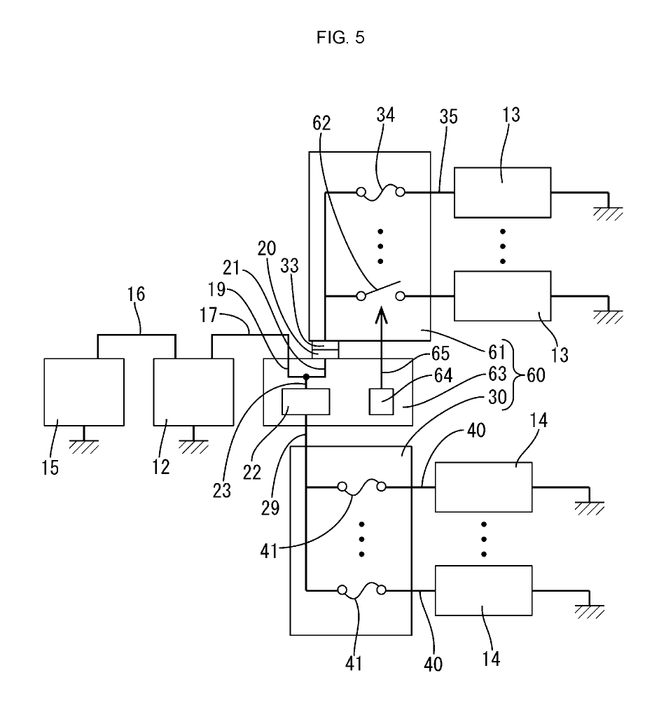

Next, a third embodiment will be described, with reference to FIG. 5. In a power system 60 according to the present embodiment, a 48V load 13 that operates with electric power of 48V is electrically connected to a high-voltage power box 61, and, in the high-voltage power box 61, a semiconductor switching element 62 is arranged between a high-voltage side busbar 33 and a 48V load 13 (first load). A FET (Field-Effect Transistor), a bipolar transistor or the like can be used for the semiconductor switching element 62.

A CPU 64 (Central Processing Unit) that controls ON/OFF of the semiconductor switching element 62 is arranged in the voltage transformation device 63. The CPU 64 is an example of a control unit. The control unit is able to detect that an overcurrent flowed between the high-voltage side busbar 33 and the 48V load 13, using a well-known technique.

The CPU 64 is configured to turn off the semiconductor switching element 62 when it is detected that an overcurrent flowed between the high-voltage side busbar 33 and the 48V load 13.

A signal line 65 is electrically connected to the CPU 64. This signal line 65 is lead from the voltage transformation device 63, and is lead into the high-voltage power box 61. The voltage transformation device 18 and the signal line 65 can be connected using a well-known connector structure. Also, the high-voltage power box 61 and the signal lines 65 can be connected using a well-known connector structure.

The signal line 65 lead into the high-voltage power box 61 is electrically connected to the semiconductor switching element 62, enabling signals regarding ON/OFF that are output from the CPU 64 to be transmitted to the semiconductor switching element 62.

Because the configuration other than the above is substantially similar to the first embodiment, the same reference signs are given to members that are the same, and redundant description will be omitted.

According to the present embodiment, a fuse is not required, thus enabling an arc that occurs when removing a fuse from a high-voltage power box at the time of fuse replacement to be suppressed.

Also, according to the present embodiment, ON/OFF of the 48V load 13 is executed by the semiconductor switching element 62, thus enabling the occurrence of an arc to be suppressed as in the case where a mechanical relay is used.

### Other Embodiments

The technology disclosed in this specification is not limited to the embodiments that are described above using the drawings, and embodiments such as the following, for example, are encompassed in the technical scope of the technology disclosed in this specification.

In the above embodiments, the first voltage is given as 48V, but is not limited thereto, and can be set to a suitable voltage according to need, such as 24V or 42V.

In the above embodiments, the second voltage is given as 12V, but is not limited thereto, and can be set to a suitable voltage that is lower than the first voltage, such as 6V or 24V.

In the first and third embodiments, a configuration is adopted in which in which the voltage transformation devices 18 and 63 are supplied electric power from the 48V electrical storage device 12, but a configuration may be adopted in which the voltage transformation devices 18 and 63 are also supplied electric power from the 48V generator 15. In the second embodiment, a configuration is adopted in which the high-voltage power box 51 is supplied electric power from the 48V electrical storage device 12, but a configuration may be adopted in which the high-voltage power box 51 is also supplied electric power from the 48V generator 15.

In the above embodiments, a configuration is adopted in which the voltage-transformation side busbar of the voltage transformation device and the high-voltage side busbar of the high-voltage power box are detachably connected, but the present invention is not limited thereto, and a configuration may be adopted in which the voltage transformation device and the high-voltage side power box are detachably connected by a male terminal provided in one thereof fitting into a female terminal provided in the other thereof.

What is claimed is:

1. A power system comprising:
a voltage transformation device configured to step down an input first voltage to a second voltage lower than the first voltage and to output the resultant voltage;
a high-voltage power box electrically connected to the voltage transformation device and configured to output electric power of the first voltage; and
a low-voltage power box electrically connected to the voltage transformation device and configured to output electric power of the second voltage,
wherein the voltage transformation device and the high-voltage power box are configured to be detachably connected to each other.

2. The power system according to claim 1,
wherein the voltage transformation device includes a circuit board and a voltage-transformation side busbar,
the high-voltage power box includes a high-voltage side busbar, and
the voltage-transformation side busbar and the high-voltage side busbar are electrically connected by a bolt and a nut screwed onto the bolt.

3. The power system according to claim 2
wherein the circuit board of the voltage transformation device has:
a voltage-transformation side input conduction path to which the first voltage is applied;
a voltage-transformation side first branch path branching from the voltage-transformation side input conduction path and electrically connected to the voltage-transformation side busbar; and
a voltage-transformation side second branch path branching from the voltage-transformation side input conduction path and electrically connected to a DC-DC converter.

4. The power system according to claim 2,
wherein the high-voltage power box has:
a high-voltage side input conduction path to which the first voltage is applied;
a high-voltage side first branch path branching from the high-voltage side input conduction path and electrically connected to the high-voltage side busbar; and
a high-voltage side second branch path branching from the high-voltage side input conduction path and configured to supply electric power to a first load that operates at the first voltage.

5. The power system according to claim 2,
wherein a first load that operates with electric power of the first voltage is electrically connected to the high-voltage power box,
in the high-voltage power box, a semiconductor switching element is arranged between the high-voltage side busbar and the first load,
a control unit is arranged in the voltage transformation device, and
the control unit is configured to turn off the semiconductor switching element, when it is detected that an overcurrent flowed between the high-voltage side busbar and the first load.

6. The power system according to claim 3, wherein a first load that operates with electric power of the first voltage is electrically connected to the high-voltage power box,
in the high-voltage power box, a semiconductor switching element is arranged between the high-voltage side busbar and the first load,
a control unit is arranged in the voltage transformation device, and
the control unit is configured to turn off the semiconductor switching element, when it is detected that an overcurrent flowed between the high-voltage side busbar and the first load.

7. The power system according to claim 4, wherein a first load that operates with electric power of the first voltage is electrically connected to the high-voltage power box,
in the high-voltage power box, a semiconductor switching element is arranged between the high-voltage side busbar and the first load,
a control unit is arranged in the voltage transformation device, and
the control unit is configured to turn off the semiconductor switching element, when it is detected that an overcurrent flowed between the high-voltage side busbar and the first load.
